(19) United States
(12) Patent Application Publication
(10) Pub. No.: US 2010/0257839 A1
(43) Pub. Date: Oct. 14, 2010

(54) Hydrocarbon-fueled rocket engine with endothermic fuel cooling

(75) Inventors: William B. Watkins, Tequesta, FL (US); Joaquin H. Castro, West Palm Beach, FL (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/504,167

(22) Filed: Aug. 15, 2006

(51) Int. Cl. B64G 1/40; F02K 99/00

(52) U.S. Cl. 60/204; 60/267

(57) ABSTRACT

A rocket engine utilizes a kerosene-based fuel in a supercritical state which is catalytically converted to lighter hydrocarbons with heat from a thrust chamber assembly which operates as a heat exchanger. This process is facilitated by a fuel stabilization deoxygenator system which removes dissolved oxygen and/or by inerting the internal surfaces of the fuel-cooled combustion chamber wall passages by applying a zeolite-based catalyst coating to permit the fuel to be heated beyond normal temperature ranges. The supercritical kerosene-based fuel is passed through a turbine and injected into the combustion chamber to burn with the gaseous oxidizer. An increased mixing efficiency between the gaseous components results in an increase in combustion efficiency and increased stability of combustion.

### BACKGROUND OF THE INVENTION

The present invention relates to a fuel system for a rocket engine, and more particularly to a rocket engine fuel system which utilizes supercritical kerosene as the fluid to provide an uncomplicated, reliable engine with increased combustion efficiency.

There are three basic types of rocket engine cycles which utilize pumped propellants. A Gas Generator and a Preburner Cycle engine each contain a main burner in the rocket chamber and a separate burner dedicated to generating expanding gases that power pump turbines, which may lead to complications with regard to reliability and control. An expander cycle has only one burner, the main burner in the rocket combustion chamber. The pump turbine is driven by expanding fuel that has received heat from cooling the combustion chamber. The expander cycle conventionally operates only with a hydrogen fuel.

With the increasing need for safe storable propellant systems, Kerosene-fueled reusable rocket engines are of growing prevalence. Kerosene-fueled rocket engines operate at high combustion pressures (to increase thrust and specific impulse, and reduce weight) and utilize more of the heat sink capability of the fuel to accommodate the increased heat fluxes that result. However, liquid Kerosene-fueled rocket engines may suffer from combustion instability.

Accordingly, it is desirable to provide a Kerosene-fueled expander cycle rocket engine with increased combustion efficiency, increased combustion stability, and better ignition operation in an expander cycle.

### SUMMARY OF THE INVENTION

The rocket engine of the present invention utilizes a deoxygenator system upstream of a fuel cooled combustion chamber wall through which the fuel passes in a heat exchange relationship. Deoxygenated fuel is heated within the fuel-cooled combustion chamber wall to convert a kerosene-based fuel to an endothermic state.

In the endothermic state, the fuel is catalytically converted to lighter hydrocarbons and heat from the thrust chamber is absorbed by the chemical change. This process is facilitated by the fuel stabilization deoxygenator system which removes dissolved oxygen and/or by inerting the internal surfaces of the heat exchanger by applying a wall surface zeolite-based catalyst coating that allows the fuel to be heated beyond normal temperature ranges without decomposition known as “coking.”

The supercritical kerosene-based fuel is then passed through a turbine and injected into the combustion chamber to burn with the oxidizer. The supercritical kerosene-based fuel is more like a gas, in that the surface tension normally found in a liquid is essentially eliminated. This is significant for a rocket in that mixing gaseous supercritical kerosene, with the oxidizer is much more efficient than mixing a liquid kerosene fuel with the oxidizer. The increase in mixing efficiency results in an increase in combustion efficiency and increased stability of combustion.

The present invention therefore provides a Kerosene-fueled expander cycle rocket engine with increased combustion efficiency, increased combustion stability, and better ignition operation in an expander cycle.

These and other features of the present invention can be best understood from the following specification and drawings, the following of which is a brief description.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of a rocket engine embodiment for use with the present invention.

### DETAILED DESCRIPTION OF THE PREFERRED EMBODIMENT

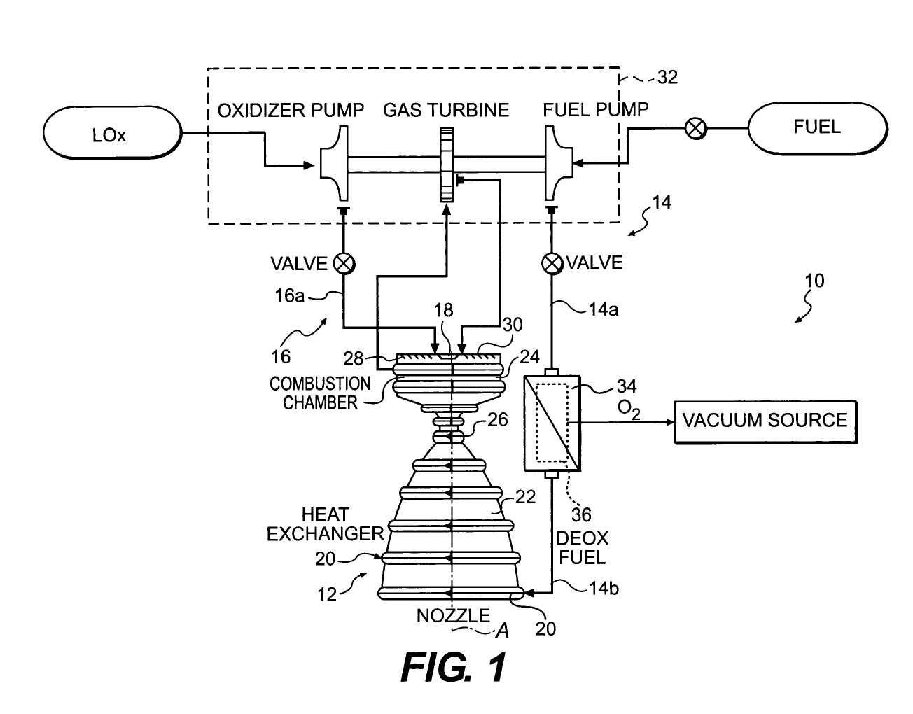

FIG. 1 illustrates a schematic view of a rocket engine 10. The engine 10 generally includes a thrust chamber assembly 12, a fuel system 14, an oxidizer system 16 and an ignition system 18. The fuel system 14 and the oxidizer system 16 preferably provide a gaseous propellant system of the rocket engine 10. It should be further understood that although an expander cycle type rocket engine is illustrated in the disclosed embodiment other rocket engine power cycle types including but not limited to Gas-generator cycle, Staged combustion cycle, and Pressure-fed cycle will also benefit from the present invention.

A fuel-cooled combustion chamber wall 20 about a thrust axis A defines the thrust chamber assembly 12. The thrust chamber assembly 12 includes a nozzle 22, a combustion chamber 24 upstream of the nozzle 22, and a combustion chamber throat 26 therebetween. The combustion chamber 24 includes an injector face 28 with a multitude of fuel/oxidizer injector elements 30 (shown schematically) which receive fuel such as the JP (jet propellant) series which passes first through the fuel cooled combustion chamber wall 20 fed via fuel supply line 14a of the fuel system 14 and an oxidizer such as Liquid Oxygen (LOx) or a liquid oxidizer high strength hydrogen peroxide through an oxidizer supply line 16a of the oxidizer system 16.

The fuel system 14 includes a deoxygenator system 34 upstream of the fuel cooled combustion chamber wall 20. The fuel-cooled combustion chamber wall 20 operates as a heat exchanger through which the fuel passes in a heat exchange relationship. By first passing the fuel through the deoxygenator system 34, oxygen is selectively removed such that the heat sink temperature capacity of the fuel is increased which translates into increased power available to the turbine 32 and thus an increase impulse power rocket engine 10. Typically, lowering the oxygen concentration to approximately 5 ppm is sufficient to overcome the coking problem and allows the fuel to be heated to over approximately 800° F. during heat exchange, for example. Notably, temperature between 800° F. and 1000° F. are considered the supercritical state while 1000° F. to 1300° F. are considered the endothermic state. It should be understood that even a relatively low reduction of the oxygen concentration will provide significant benefits in liner life as deoxygenated fuel will primarily be utilized to the nozzle throat and areas where the heat fluxes and coke deposits may otherwise be relatively high.

As the fuel passes through the deoxygenator system 34, oxygen is selectively removed such as into a vacuum or sweep-gas system 36. The sweep gas may be any gas that is essentially free of oxygen. The deoxygenated fuel flows from a fuel outlet of the deoxygenation system 34 via a deoxygenated fuel conduit 14b to the fuel cooled combustion chamber wall 20. It should be understood that although a particular component arrangement is disclosed in the illustrated embodiment, other arrangements will benefit from the instant invention.

For further understanding of other aspects of one membrane based fuel deoxygenator system and associated components thereof which are capable of processing high flow rates characteristic of rocket engines in a compact and lightweight assembly, and lowering dissolved oxygen concentration sufficiently to suppress coke formation, attention is directed to U.S. Pat. No. 6,315,815 entitled MEMBRANE BASED FUEL DEOXYGENATOR; U.S. Pat. No. 6,939,392 entitled SYSTEM AND METHOD FOR THERMAL MANAGEMENT and U.S. Pat. No. 6,709,492 entitled PLANAR MEMBRANE DEOXYGENATOR which are assigned to the assignee of the instant invention and which are hereby incorporated herein in their entirety.

From the deoxygenator system 34, deoxygenated fuel is heated within the fuel-cooled combustion chamber wall 20 to convert a kerosene-based fuel to a supercritical state. The fuel may be heated to an upper limit temperature of about 1300 F and preferably is heated to greater than about 800° F. such that the pressure thereof increase above about 350 pounds per square inch to obtain the supercritical state.

Endothermic fuels are fuels which have the capacity to absorb large quantities of physical and chemical heat. Endothermic fuels are capable of absorbing sensible and latent heat and, therefore, have a physical heat sink. In addition, endothermic fuels are capable of absorbing a heat of reaction to initiate an endothermic decomposition reaction. The capacity to absorb a heat of reaction is referred to as the fuel's chemical heat sink. By combining the physical and chemical heat sinks of an endothermic fuel, the fuel is capable of absorbing two to four times as much heat as fuels which are used only as physical heat sinks and up to twenty times more heat than conventional turbine fuels that are limited to moderate temperatures by their propensity to decompose and form deposits. For further understanding of other aspects of the endothermic conversion of kerosene to lighter hydrocarbons and associated components thereof, attention is directed to U.S. Pat. Nos. 5,151,171 entitled METHOD OF COOLING WITH AN ENDOTHERMIC FUEL; 5,176,814 entitled METHOD OF COOLING WITH AN ENDOTHERMIC FUEL; and 5,232,672 entitled ENDOTHERMIC FUEL SYSTEM which are assigned to the assignee of the instant invention and which are hereby incorporated herein in its entirety.

In the supercritical state, the fuel is catalytically converted to lighter hydrocarbons and heat from the thrust chamber is absorbed by the chemical change. This process is facilitated by the catalyst coating and/or the fuel stabilization deoxygenator system which removes dissolved oxygen through an in-line unit and by inerting the internal surfaces of the heat exchanger by applying a wall surface catalyst coating or the like that allows the fuel to be heated beyond its normal temperature range without unintentional decomposition known as “coking” (normally fuel is not heated hotter than 300-400 F due to coking).

The fuel-cooled combustion chamber wall 20 provides heat exchanger passages in the rocket engine thrust chamber assembly 12 such that the thrust chamber assembly 12 itself operates as a heat exchanger. The passages defined within the fuel-cooled combustion chamber wall 20 are coated with a zeolite based coating that operates as a catalyst to the cracking reaction also reducing the formation of solid carbon particles (soot) allowing the kerosene-based fuel to be utilized in a higher temperature environment which enhances cracking. The cracking reaction is achieved by subjecting the hydrocarbon fuel to heat and pressure. The heat capacity of the kerosene-based fuel controls the temperature of the structure to prevent damage while the heat absorbed by the kerosene-based fuel is increased to convert the kerosene-based fuel into lighter hydrocarbons. It should be understood that although the fuel-cooled combustion chamber wall 20 operates as the heat exchanger, other dedicated in-line units may alternatively or additionally be provided.

The supercritical kerosene-based fuel is then passed through a turbine 32 and injected into the combustion chamber 24 (FIG. 1) to burn with the gaseous oxidizer as generally understood. The supercritical kerosene-based fuel is more like a gas, in that the surface tension normally found in a liquid is essentially eliminated. This is significant for a rocket engine in that mixing gaseous fuel, which is the supercritical kerosene, with the gaseous oxidizer is much more efficient than mixing a liquid kerosene fuel with gaseous oxidizer. The increase in mixing efficiency results in an increase in combustion efficiency and increased stability of combustion. It should also be understood that the supercritical kerosene-based fuel in a gaseous state enhances its applicability for transpiration cooling in any of the components of the thrust chamber assembly 12.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

Although a preferred embodiment of this invention has been disclosed, a worker of ordinary skill in this art would recognize that certain modifications would come within the scope of this invention. For that reason, the following claims should be studied to determine the true scope and content of this invention.

1. A rocket engine comprising:
a thrust chamber assembly;
a heat exchanger in communication with said thrust chamber assembly;
a deoxygenator system in fluid communication with said heat exchanger to deoxygenate a kerosene-based fuel to form a deoxygenated kerosene-based fuel; and
a fuel system in communication with said thrust chamber assembly through said heat exchanger and said deoxygenator system to heat the deoxygenated kerosene-based fuel and increase a pressure of the deoxygenated kerosene-based fuel so as to convert the deoxygenated kerosene-based fuel to an endothermic state for communication to said thrust chamber assembly.

2. The rocket engine as recited in claim 1, wherein said heat exchanger includes a fuel-cooled combustion chamber wall.

3. The rocket engine as recited in claim 1, wherein said fuel system heats the deoxygenated kerosene-based fuel to greater than about 1000 F and increases the pressure above about 350 pounds per square inch.

4. The rocket engine as recited in claim 1, wherein said fuel system mixes the deoxygenated kerosene-based fuel with an oxidizer within said thrust chamber assembly.

5. The rocket engine as recited in claim 1, wherein said fuel system includes an expander cycle in communication with said thrust chamber assembly.

6. The rocket engine as recited in claim 1, wherein said thrust chamber assembly includes a combustion chamber upstream of a nozzle, and a combustion chamber throat therebetween.

7. The rocket engine as recited in claim 1, wherein said deoxygenator system is upstream of said heat exchanger.

8. The rocket engine as recited in claim 1, wherein said heat exchanger includes a zeolite-based catalyst coating.

9-11. (canceled)

12. A method of increasing a combustion stability of a rocket engine comprising:
deoxygenating a kerosene-based fuel to form a deoxygenated kerosene-based fuel;
communicating the deoxygenated kerosene-based fuel through a heat exchanger to heat the deoxygenated kerosene-based fuel and increase a pressure of the deoxygenated kerosene-based fuel so as to convert the deoxygenated kerosene-based fuel to an endothermic state; and
communicating the kerosene-based fuel in the endothermic state from the heat exchanger into a thrust chamber assembly.

13. (canceled)

14. A method as recited in claim 12, further comprising:
communicating the deoxygenated kerosene-based fuel through the heat exchanger system to heat the deoxygenated kerosene-based fuel to greater than about 1000 F and increases the pressure of the deoxygenated kerosene-based fuel to above 350 pounds per square inch.

15. A method as recited in claim 12, further comprising:
communicating the deoxygenated kerosene-based fuel from the heat exchanger to a turbine prior to communication into the thrust chamber assembly.

16. (canceled)

17. A method as recited in claim 12, further comprising:
utilizing the deoxygenated kerosene-based fuel for transpiration cooling of a component of the rocket engine.

18. A method of increasing a combustion stability of a rocket engine comprising the steps of:
(A) communicating a kerosene-based fuel through a heat exchanger including a zeolite-based catalyst coating to convert the kerosene-based fuel to an endothermic state; and
(B) communicating the endothermic state kerosene-based fuel into a thrust chamber assembly.

19. A method as recited in claim 18, wherein said step (B) further comprises:
(a) communicating the deoxygenated kerosene-based fuel through the heat exchanger system to heat the deoxygenated kerosene-based fuel to greater than about 1000 F to obtain the endothermic state.

20. A method as recited in claim 18, further comprising the step of:
(C) utilizing the endothermic state kerosene-based fuel for transpiration cooling of a component of the rocket engine.
